(19) United States
(12) Patent Application Publication
(10) Pub. No.: US 2002/0073103 A1
(43) Pub. Date: Jun. 13, 2002

(54) Memory garbage collection method and apparatus

(76) Inventors: Thomas Mark Walter Bottomley, Orleans (CA); Ian E. Gorman, Ottawa (CA)

Correspondence Address: Pillsbury Madison & Sutro LLP, Intellectual Property Group, 50 FREMONT STREET, SAN FRANCISCO, CA, 94105-2228, US

(21) Appl. No.: 09/736,481

(22) Filed: Dec. 13, 2000

Related U.S. Application Data
(60) Provisional application No. 60/227,872, filed on Aug. 25, 2000.

(51) Int. Cl. G06F 12/00

(52) U.S. Cl. 707/200

(57) ABSTRACT

A method and apparatus of efficiently reclaiming computer memory, which may be applied in a real-time system. The efficient garbage collector method and apparatus embodiments run concurrently with application threads, and operate correctly while the application threads are obtaining and releasing memory blocks. Newly allocated blocks will not be reclaimed, and blocks that go out of use during a collection cycle will be reclaimed in the next cycle.

### RELATED APPLICATIONS

This application claims the benefit of co-pending U.S. Provisional Application Serial No. 60/227,872 filed Aug. 25, 2000.

### BACKGROUND

1. Field of the Invention

Aspects of the present invention relate in general to arrangements for computer memory garbage collection. More specifically, the invention is directed to an arrangement for making computer memory garbage collection more efficient than in known arrangements.

2. Description of Related Art

In a system that implements the Java™ computer language, a trademark of Sun Microsystems, Inc. of Palo Alto, Calif., application programs can request blocks of computer memory (i.e., “electronic memory,”) for various purposes from an area of memory known as the “heap.” In contrast to other kinds of systems, application code processes do not have to notify the system that a block of memory is no longer needed. The Java system identifies those blocks that are no longer in use, and recovers those blocks. This process of memory reclamation is known as “garbage collection.”

There are two general methods of garbage collection. A so-called reference counting method keeps a record of references to memory as they are made and broken, and recovers memory blocks when there are no more references. Mark-and-sweep garbage collectors survey a system to “mark” or identify blocks that are still in use, and then recover or “sweep” the unmarked “garbage” blocks. Variations on both of these general types include the “copying” garbage collectors, which move the unrecovered blocks into contiguous locations to make larger blocks of free space available for subsequent memory requests from the system.

In order to survey a working system, a mark-and-sweep garbage collector needs to work with an unchanging set of data. Otherwise, in the time taken to survey the system, the data may have changed, and the information obtained by the garbage collector may have become inaccurate.

Conventional systems deal with this problem by stopping all application code while the garbage collector surveys the system. The survey can take time, on the order of a second or more. In an embedded real-time system, which has to respond to events at intervals of milliseconds, or microseconds, the stopping of all application code process is a severe detriment.

Dijkstra et al., proposed a method of marking and sweeping unused computer memory in “On-the-Fly Garbage Collection: An Exercise in Cooperation,” Communications of the ACM, 21(11):965-975, November 1978.

Dijkstra et al. show that marking and sweeping can be done incrementally in a running real-time system, interleaving the operation with normal processing without either releasing memory that is still in use, or failing to ultimately retrieve a memory block that is not in use. Dijkstra et al. represented memory allocation as a graph, with nodes corresponding to memory blocks, each at a specific address, and arcs corresponding to references between blocks. It is understood, by those known in the art, that the terms memory “blocks” and “nodes” may be used interchangeably.

Assuming a fixed set of nodes, Dijkstra et al. divided the nodes into three changing subsets: “live,” “garbage,” and “free.” The “garbage” nodes are those that are no longer live, but have not been moved to the “free” subset.

Dijkstra et al. also assumed a fixed set of roots, enumerated prior to traversing the entire set of nodes, to mark the nodes that are currently in use. Roots are defined as memory blocks or nodes that can be reached directly from at least one of the working threads or processes in the system. An example root is when one of the thread variables contains the address of a memory block. Other nodes may only be indirectly reachable via addresses in a chain of blocks, each with an address to the next, but only the first block in the chain being a root.

Live data is data that is required by a computation, and reachable either directly or indirectly by following a path of pointers from a root. Their algorithm identifies a subset of the fixed set of nodes as “garbage” nodes, and moves that subset to the free set. The assumption of a fixed set of roots, and a fixed set of nodes supports the reliability of their algorithm.

The algorithm enumerates a root set, where no nodes can appear. Consequently, it is possible to identify a complete set of roots. The algorithm marks the graph, under their assumption that no nodes can disappear, and no new roots can appear. It is therefore possible to enumerate all nodes, and to trace all paths to a reachable node, while trying to identify the complete graph or reachable nodes, even though the connections between the nodes are continually being changed by the system.

While the Dijkstra et al. algorithm appends nodes to the free list, the total set of nodes (live, garbage, and free) is unchanging, so it is possible to establish the start conditions for the next garbage collection cycle by unmarking all nodes as the nodes are appended to the free list.

### BRIEF DESCRIPTION OF THE DRAWINGS

FIG. 1 is a block diagram of an arrangement that efficiently garbage collects unused computer memory.

FIG. 2 is a schematic diagram illustrating a structure that efficiently reclaims unused computer memory.

FIG. 3 is a flowchart of a method embodiment that efficiently garbage collects unused computer memory.

FIG. 4 flowcharts a snapshot phase of a method embodiment that efficiently reclaims unused computer memory.

FIG. 5 is a flowchart of a root phase of a method embodiment that efficiently garbage collects unused computer memory.

FIG. 6 flowcharts a marking phase of a method embodiment that efficiently reclaims unused computer memory.

FIG. 7 is a flowchart of a sweep phase of a method embodiment that efficiently garbage collects unused computer memory.

FIGS. 8A-D represent example memory nodes.

FIGS. 9A-F illustrate a memory allocation example of an efficient garbage collection of unused computer memory nodes.

### DETAILED DESCRIPTION

Aspects of the invention encompass the discovery of flaws, problems, and improvements upon the Dijkstra et al. garbage collection algorithm, process, and apparatus. Apparatus and method embodiments of the invention further facilitate the requirements for a real-time incremental memory garbage collector in a Java system.

The Discovery of Flaws in the Prior Art

Often, invention springs from the recognition of a flaw or problem in a known system. The inventors of the claimed inventions recognized that the Dijkstra et al. algorithm does not meet all of the requirements of a real-time incremental garbage collector.

Dijkstra et al. assumes that there is a fixed set of memory nodes. This assumption does not allow memory fragmentation to be controlled by splitting and joining memory blocks. Moreover, the assumption conflicts with the need for arbitrarily sized memory blocks to fit the needs of Java class instances, whose size are only known during runtime execution.

Moreover, in a real-time system, the set of roots is subject to constant change. To achieve reliable results under the Dijkstra et al. algorithm, the emergence of new roots is not allowed between the marking of a root identification phase, and the end of the marking phase. Preventing new roots from emerging is conventionally accomplished by stopping the system-which adversely affects the performance of a real-time system.

Dijkstra et al. requires the enumeration of all nodes in a memory graph, including the live nodes, the garbage nodes, and the free nodes. Enumeration of the free nodes is not efficient, as it interferes with the management of free memory from the incremental operation of the garbage collector.

Conventional real-time systems cannot be stopped while a garbage collector is operating, particularly when there is no hard upper bound on the time that the garbage collector will require. However, a system with enough memory may be able to tolerate a delay of one garbage collection cycle in reclaiming blocks that go out of use in the current cycle.

The efficient garbage collector method and apparatus embodiments of the present invention run concurrently with application threads, and operate correctly while the application threads are obtaining and releasing memory blocks, and operate while the set of root nodes is changing. The method does not require the free blocks to be scanned, and allows both the total number and the size of memory blocks to vary. Newly allocated blocks will not be reclaimed, and blocks that go out of use during a collection cycle will be reclaimed in the next cycle.

Exemplary Embodiments of the Present Invention

Like Dijkstra et al., the embodiments use a fixed set of nodes to make it easier to prove the correctness of the garbage collection procedure. However unlike Dijkstra et al., the embodiments define the fixed set in such a way that the total number of memory blocks, the number of live memory blocks, and the root set can all change during a garbage collection cycle. Since new blocks can be allocated at any time, there is no constraint that the blocks have particular sizes. In the embodiments, no reachable block will be reclaimed, in spite of the changes.

Embodiments of the invention include apparatus, garbage collector, and methods that efficiently reclaim unused computer memory nodes. Garbage collector embodiments may mark-and-sweep computer memory while the allocation of memory is simultaneously being changed by other processes. New connections or paths between memory nodes cause memory blocks to be retained, even if the new connections are made after a block has been inspected for connections, and old connections have been broken before the block has been inspected for connections.

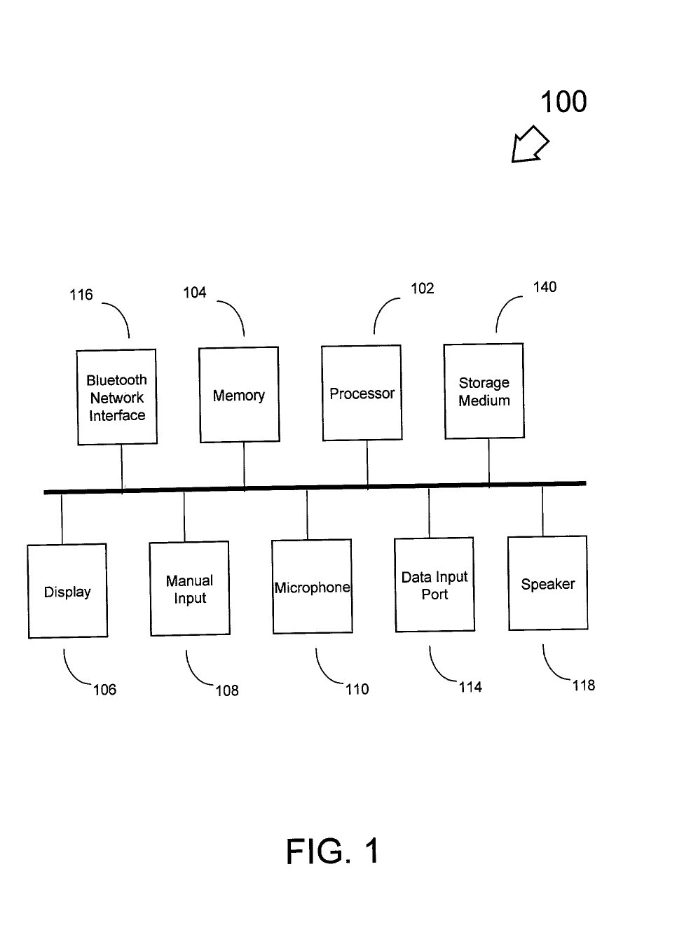

FIG. 1 is a simplified functional block diagram depicting apparatus 100, constructed and operative in accordance with an embodiment of the present invention. Apparatus 100 is configured as a real-time system that uses a memory garbage collector embodiment of the present invention.

Apparatus 100 includes at least one processor 102, sometimes referred to as a central processing unit or “CPU.” Processor 102 may be any processor, microprocessor, microcomputer, or micro-controller device known in the art. The software for programming the processor 102 may be found at a computer-readable storage medium 140 or, alternatively, from another location across a network. Processor 102 is connected to computer memory 104. Computer memory may be divided into memory blocks. When graphing memory allocations, memory blocks may be represented as nodes.

Additional peripheral equipment may include a display 106, manual input device 108, storage medium 140, microphone 110, data input port 114, speaker 118, and Bluetooth network interface 116.

Display 106 may be a visual display such as a cathode ray tube (CRT) monitor, a liquid crystal display (LCD) screen, touch-sensitive screen, or other view screens as are known in the art for visually displaying images and text to a user.

Manual input device 108 may be a conventional keypad, keyboard, mouse, trackball, pointing device, or other input device as is known in the art for the manual input of data.

Storage medium 140 may be a conventional read/write memory such as a magnetic disk drive, magnetic fixed (“hard”) drive, magneto-optical drive, optical drive, floppy disk drive, compact-disk read-only-memory (CD-ROM) drive, digital video disk read-only-memory (DVD-ROM), digital video disk read-access-memory (DVD-RAM), transistor-based memory or other computer-readable memory device as is known in the art for storing and retrieving data. Significantly, storage medium 140 may be remotely located from processor 102, and be connected to processor 102 via a network such as a Personal Area Network (PAN), a local area network (LAN), a wide area network (WAN), or the Internet. An example of a personal area network includes a Bluetooth personal area network connected via Bluetooth network interface 116.

Microphone 110 may be any suitable microphone as is known in the art for providing audio signals to processor 102. In addition, a speaker 118 may be attached for reproducing audio signals from processor 102. It is understood that microphone 110 and speaker 118 may include appropriate digital-to-analog and analog-to-digital conversion circuitry as appropriate.

Data input port 114 may be any data port as is known in the art for interfacing with an external accessory using a data protocol such as RS-232, Universal Serial Bus (USB), or Institute of Electrical and Electronics Engineers (IEEE) Standard No. 1394 (‘Firewire’).

Network interface 116 is an interface that allows apparatus 100 to communicate via a network protocol. Network protocols include the Transmission Control Protocol/Internet Protocol (TCP/IP), Ethernet, Fiber Distributed Data Interface (FDDI), token bus, or token ring network protocols.

In some embodiments, apparatus 100 is a portable wireless device, such as a wireless phone or personal digital assistant (PDA).

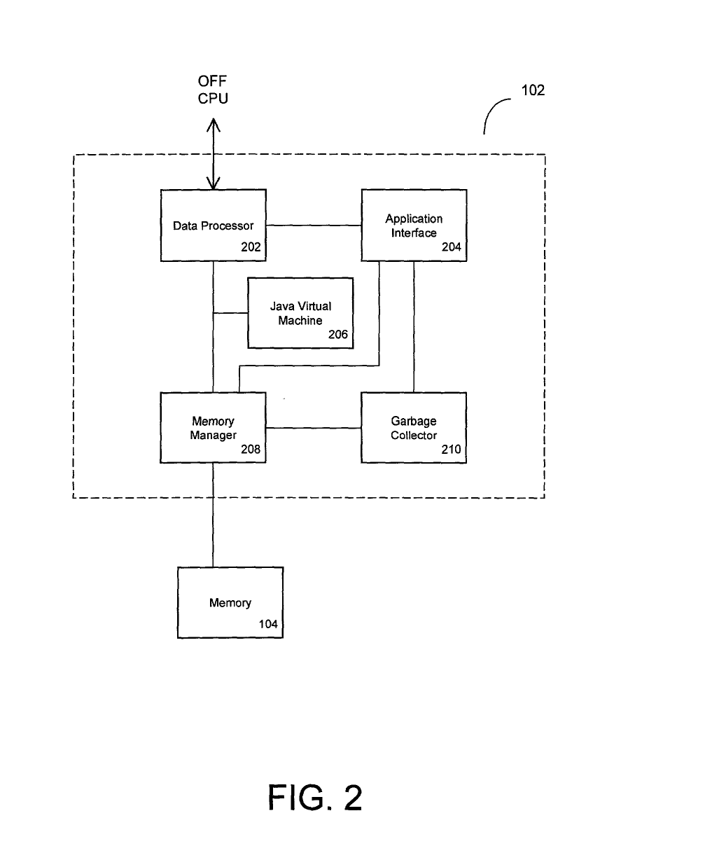

FIG. 2 is an expanded functional block diagram of processor 102 and memory 104. It is well understood by those in the art, that the functional elements of FIG. 2 may be implemented in hardware, firmware, or as software instructions and data encoded on a computer-readable storage medium 140. As shown in FIG. 2, central processing unit 202 comprises a data processor 202, an application interface 204, a virtual machine 206, a memory manager 208, and a garbage collector 210.

Data processor 202 interfaces with memory 104, display 106, manual input device 108, storage medium 140, microphone 110, data input port 114, and Bluetooth network interface 116. The data processor 202 enables processor 102 to locate data on, read data from, and write data to, these components.

Application interface 204 enables processor 102 to take some action with respect to a separate software application or entity. For example, application interface 204 may take the form of a windowing user interface, as is commonly known in the art.

Processor 102 communicates with a plurality of peripheral equipment, and may incorporate a Java Virtual Machine (“JVM”) 206. Java virtual machine 206 may be any structure that interprets Java bytecodes into machine code. It is understood that the use of a Java virtual machine is merely an example embodiment, and that the principles herein may equally apply to any virtual machine 206 that interprets the bytecodes of a computer language into machine code. In some embodiments, the virtual machine 206 performs a number of functions that can include class loading, process threading, object locking, and byte code execution.

It is well understood that Java Virtual Machine 206 may be implemented in hardware, firmware, or software encoded on a computer readable medium. A computer readable medium is any medium known in the art capable of storing information. Computer readable media include storage media 140 (as defined above), Read Only Memory (ROM), Random Access Memory (RAM), flash memory, Erasable-Programmable Read Only Memory (EPROM), non-volatile random access memory, memory-stick, magnetic disk drive, floppy disk drive, compact-disk read-only-memory (CD-ROM) drive, transistor-based memory or other computer-readable memory devices as is known in the art for storing data.

In alternate embodiments, virtual machine 206 may interpret the bytecodes of another computer language other than Java.

In yet other embodiments, processor 102 does not have a virtual machine 206.

Memory manager 208 manages memory addressing for processor 102. As is known in the art, memory manager 208 may be embodied by a memory management unit (MMU).

Garbage collector 210 is the structure that aids in the reclamation of computer memory. The garbage collector 210 assumes that the allocated memory blocks are on a linked list, and that there are ways to: get the head of the list, get the next memory block, test if any pointer corresponds to a memory block on the list, set a block to any of three marking values, test a block for any of three marking values, and free a block of memory.

The garbage collector 210 functionality is described with greater detail below.

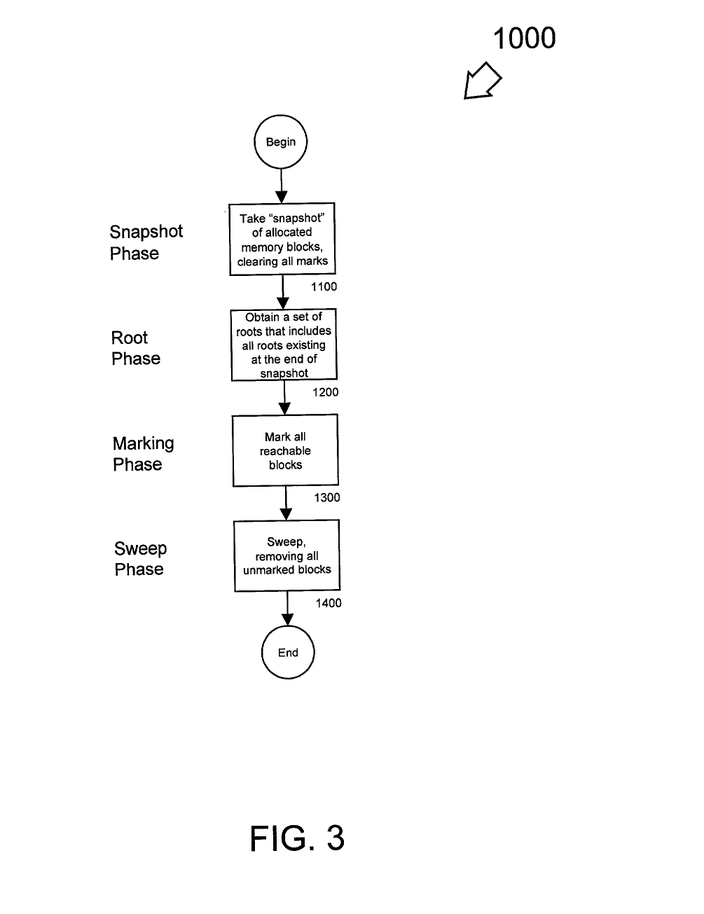

FIG. 3 is a simplified arrangement depicting process 1000, a garbage collection reclamation or “collection” cycle, constructed and operative in accordance with an embodiment of the present invention. Process 1000 allows a real time system, such as apparatus 100 or processor 102, to reclaim unused computer memory efficiently. It is understood that the collection cycle, process 1000, may be repeated a plurality of times, reclaiming unused computer memory, during the operation of apparatus 100.

The garbage collector 210 begins a collection cycle, process 1000, by taking a snapshot of the set of currently allocated memory blocks, and getting a set of roots for that snapshot. Application threads will continue to modify the root set and to allocate new memory blocks during a garbage collection cycle. At the end of the garbage collection cycle 1000, any memory block that was unused when the snapshots were taken will be put on the free list. Blocks that were allocated after the snapshot will be outside the allocation snapshot and will not be reclaimed in the cycle that took the snapshot. Blocks inside the allocation snapshot will not be reclaimed while they are reachable, even if they become unreachable from the roots of the snapshot.

The garbage collector 210 is a mark-and-sweep collector, rather than a reference-counting collector. Reference-counting collectors precisely identify all references, neither giving a reference to memory no longer used, nor failing to give a reference to memory still used, but they require a supplementary collector to clean up cycles, and they impose a run-time overhead on all uses of allocated memory. In contrast, a mark-and-sweep collector uses a set of references at least big enough to include all active memory references, but will often some of the inactive memory references which will not be recognized as inactive until the following collection cycle. The garbage collection process described herein is equally applicable the “copying collector” variant of mark-and-sweep garbage collection, which moves the remaining memory blocks into contiguous locations in memory after sweeping the garbage blocks.

Process 1000 comprises a number of sub-processes. In sub-process 1100, the snapshot phase, a snapshot of allocated memory blocks is taken. Once a snapshot is taken, the root phase, sub-process 1200, obtains a complete set of roots. The term “root” is a term known in the art. A direct reference from data in an active thread or process is commonly referred to as a “root.” Sub-process 1200 identifies a set of roots, or memory blocks that have direct references from active threads or processes. All memory blocks reachable from the root data are marked by sub-process 1300, the marking phase. In this phase, a garbage collector 210 marks all reachable memory blocks, by following references from the roots to all of the memory blocks that the active threads can reach. This sub-process 1300 builds a graph in which the nodes represent memory blocks, and arcs represent references to memory blocks. Unmarked memory blocks are reclaimed by the sweep phase and released to the free memory list, sub-process 1400.

Each sub-process is described with greater detail below.

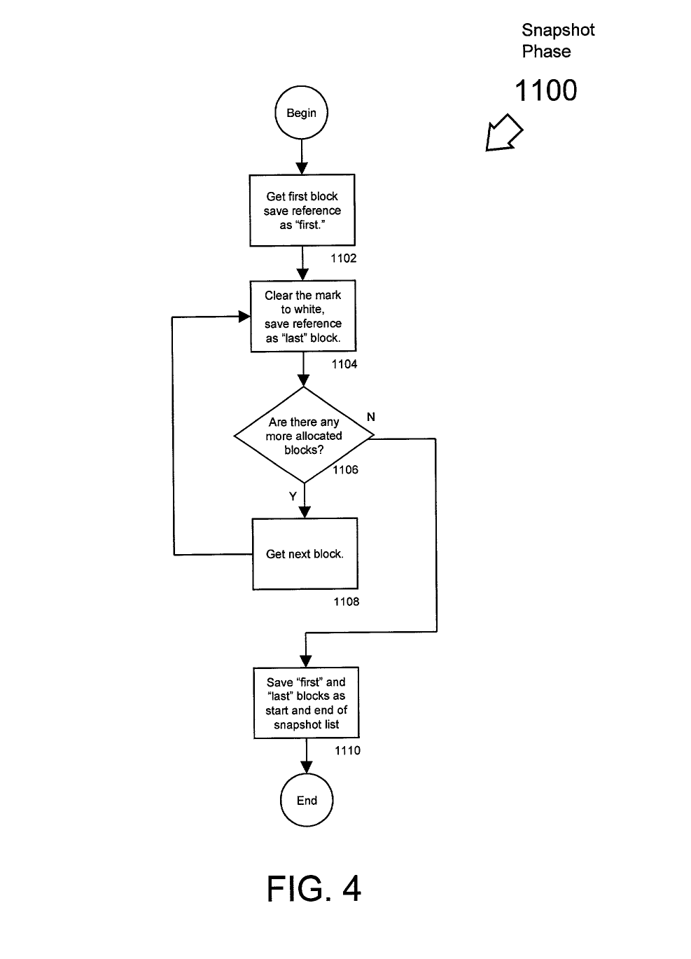

FIG. 4 flowcharts sub-process 1100, constructed and operative in accordance with an embodiment of the present invention. Sub-process 1100, the “snapshot” phase, identifies memory blocks within memory 104, currently allocated by memory manager 208.

In the snapshot phase 1100, a snapshot set of memory blocks, within memory 104, is taken. The memory blocks become nodes on which to construct a graph of the allocated computer memory. The snapshot limits the set of nodes under examination, and therefore ensures that each of the subsequent phase will eventually stop, allowing the garbage collection cycle to go on to the next phase. Each phase will stop in a reasonably short time under normal operating conditions because each phase involves operations that are never reversed and the phase stops when all of its operations are completed.

Delays in the operation of a thread or process can occur when that process requests additional memory and there is no free memory. Other threads or processes will not be delayed unless they are waiting for information from the delayed thread or process, and the delayed thread or process will resume once a garbage collection cycle has recovered (and freed) some unused memory.

The first allocated block of memory 104 is obtained by the garbage collector 210, and is saved as a “first” reference, act 1102. To obtain information about the allocation of memory blocks, garbage collector 210 contacts memory manager 208.

The current block is cleared and made “white,” and a reference to the current block is saved as the “last” block, act 1104. Sub-process 1100 then moves to the next memory block at act 1108, and processing returns to act 1104.

At act 1106, a determination is made on whether any more allocated blocks remain to be added to the snapshot. If so, the next block is obtained and act 1104 is repeated.

In conventional systems, the white, grey, and black color scheme is represented as two bits associated with each memory block. In such systems, a value of “00” is white, “01” is grey, “10” is black, and “11” is not defined.

Some embodiments adopt the representation used in conventional systems.

However, in alternate embodiments, a value of “00” is white, “01” is grey, and both “10” and “11” values are black. As will be described below in the marking phase 1300, this representation is advantageous, allowing for a more efficient marking process. The discovery and implementation of a more efficient marking process are also aspects of the present invention.

If there are no more allocated memory blocks, as determined by act 1106, the first block is saved as the “first” reference block and the final block examined is used as the “last” reference memory block, act 1110. The blocks are then used as the start and end of the snapshot list.

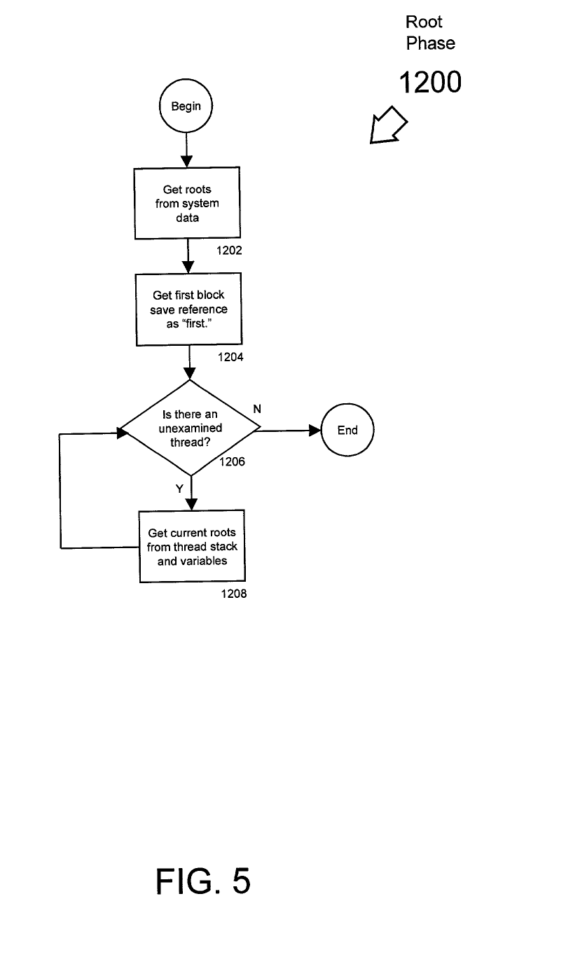

FIG. 5 flowcharts sub-process 1200, constructed and operative in accordance with an embodiment of the present invention. Sub-process 1200 identifies a set of roots, or memory blocks that have direct references from active threads or processes.

A snapshot of the root set is obtained from application thread data and system data. Conventional systems stop all application code while the garbage collector surveys the system for roots. Apparatus 100 does not do this, instead allowing the application threads to continue running, and thus remain functioning as a real-time embedded system. Although continuing operation of the system will make incremental changes to the roots, the snapshot performed by sub-process 1200 will obtain all of the roots that existed prior to the snapshot, and still remain valid. New roots created after the snapshot may not be found by sub-process 1200. However, the hardware marking process will cause these roots to be identified separately.

Initially, roots are obtained from system data, act 1202. The first block is referenced as the “first” root, act 1204. Sub-process 1200 identifies each root in system data and colors the corresponding node “grey.” Act 1206 determines whether there is an unexamined thread.

If there is an unexamined thread, garbage collector 210 gets the current roots, act 1208, and marks them “grey.” The current roots are derived from the thread stack and variables, which reference the currently active computer memory.

Continuing operation of the application threads will add more roots, which will be marked grey by the hardware as they are added, and will invalidate some roots, which will remain marked until they are cleared in the next garbage collection cycle. If there are no unexamined threads, sub-process 1200 ends.

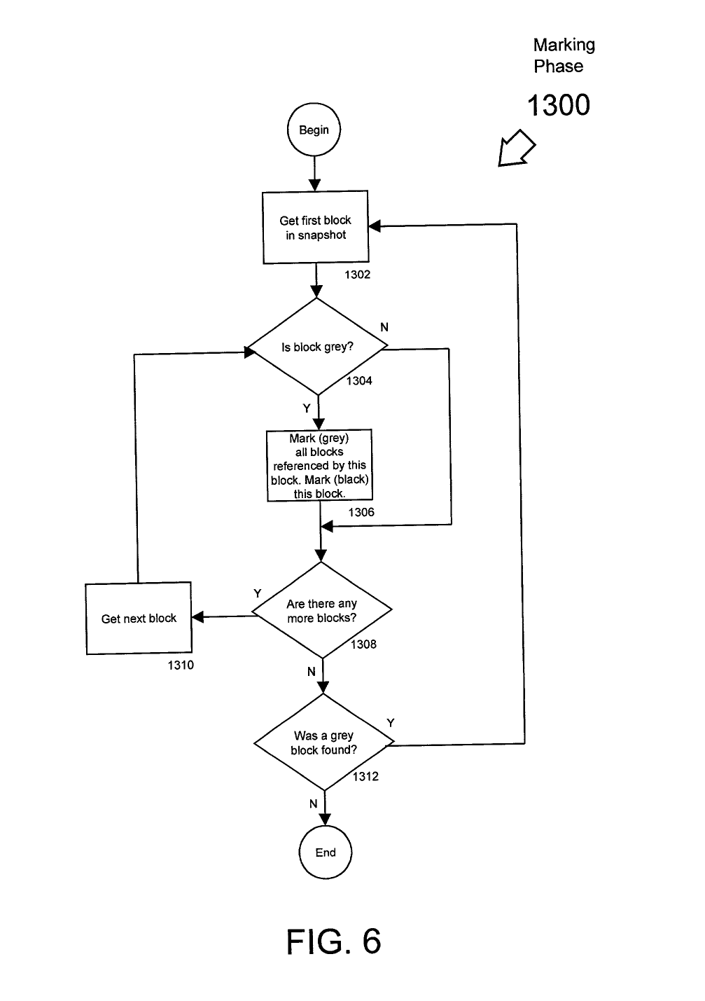

FIG. 6 flowcharts sub-process 1300, constructed and operative in accordance with an embodiment of the present invention. Sub-process 1300, the marking phase, marks all memory blocks reachable from the root data. In this phase, a garbage collector 210 marks all reachable memory blocks, by following references from the roots to all of the memory blocks that the active threads can reach. This sub-process 1300 builds a graph in which the nodes represent memory blocks, and arcs represent references to memory blocks.

The graph will include all nodes of the node snapshot that are currently live, and may also include some of the nodes that are garbage, because the nodes may fall out of use after being marked as in use. The included garbage blocks will not be recovered until the next collection cycle. All blocks within the snapshot but outside the graph will be collected in the current cycle.

At act 1302, the first block in the snapshot is examined. Act 1304 determines if the current block is grey. If the current block is grey, all blocks referenced by this block are marked (“greyed”) to indicate that they are reachable, and the current block is marked black, act 1306 to indicate that all blocks reachable from that block have been marked.

In conventional systems, during the marking (also called “greying”) of blocks, the marking is performed by checking if the color value of the block (i.e. “00”=“white,” “01”=“grey,” and “10”=black”). If the color value is either white or grey, the block is marked by adding “01” to the block value. Thus, white blocks are “elevated” to grey, and grey blocks are elevated to “black.” If the color value is black, no action is taken. Consequently, in a conventional system, the system performs a read, a compare, and then an add instruction when marking a memory block—a total of three operations.

As discussed during the snapshot phase 1100, in some embodiments, a block value of “00” is white, “01” is grey, and both “10” and “11” block values are black. Using this representation, the marking of blocks can be done in a single operation (write), instead of three (read, test write). Marking a block is accomplished by performing an OR operation with the block value and “1.” The results of such operations are as follows. White blocks (“00”) are elevated to grey (“01”). Grey blocks (“01”) are elevated to black (“10”). Black blocks (“10” or “11”) result in black blocks (“11”). Thus, in such embodiments, the marking of a memory block may be performed much more quickly.

Returning to FIG. 6, flow continues at act 1308, from act 1306 if the current block is grey or from act 1304 if the current block is not grey. At act 1308, a determination is made on whether there are any more blocks within the snapshot. If so, the next block is examined, act 1310, and flow returns to act 1304.

If no more blocks are unexamined, flow continued at act 1312. At act 1312, a determination is made on whether based on whether a grey block was found in the most recent repetition of acts from act 1302. If so, flow returns to act 1302. If not, sub-process 1300 ends.

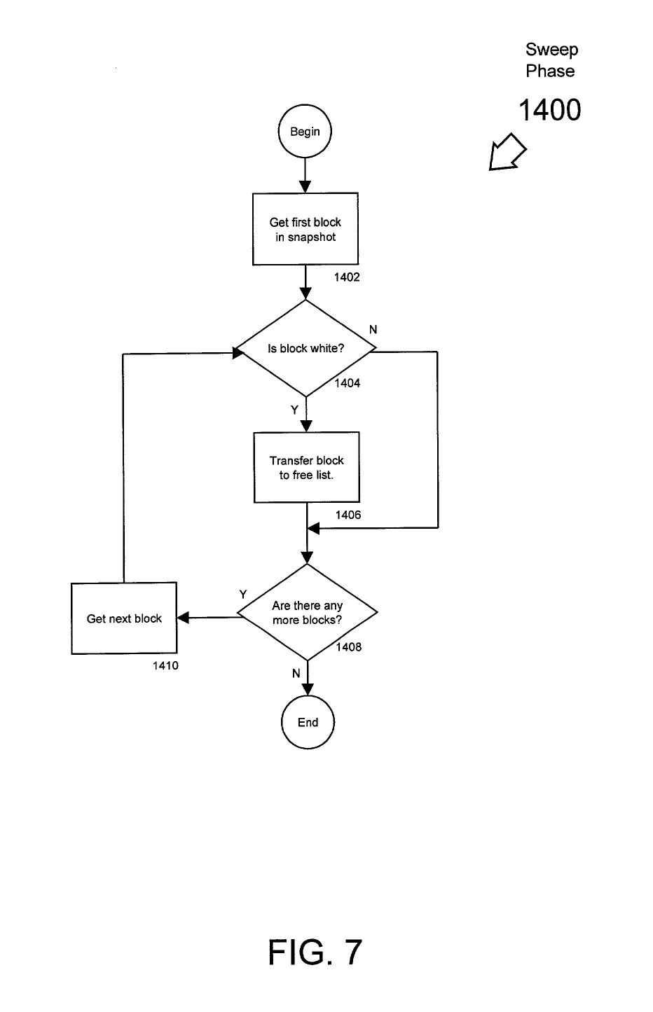

FIG. 7 flowcharts sub-process 1400, constructed and operative in accordance with an embodiment of the present invention. Unmarked memory blocks are reclaimed by the sweep phase and released to the free memory list during sub-process 1400, known as the sweep phase. The act of freeing a memory block is also known as “sweeping” the memory block.

Sweeping the node snapshot frees all of the nodes that are not in the “active data” graph, inserting the nodes on a free list. It is worth noting that the continuing operation of application threads will have no effect on this phase. Thus application threads do not need to be suspended during the garbage collection process 1000 embodiment.

At act 1402, the first block in the snapshot is examined. Act 1404 determines if the current block is white. If the current block is white, the block is transferred (or “swept”) to the free memory list, act 1406. IF the current block is not white, as determined by act 1404, flow continues at block 1408.

At act 1408, a determination is made on whether there are any more blocks within the snapshot. If so, the next block is examined, act 1410, and flow returns to act 1404. If no more blocks are unexamined, sub-process 1400 ends.

Thus, at the end of sub-process 1400, all white blocks from the original snapshot are transferred to the free memory list. The garbage collection cycle 1000 ends. In some embodiments, another garbage collection cycle 1000 can start immediately after another ends.

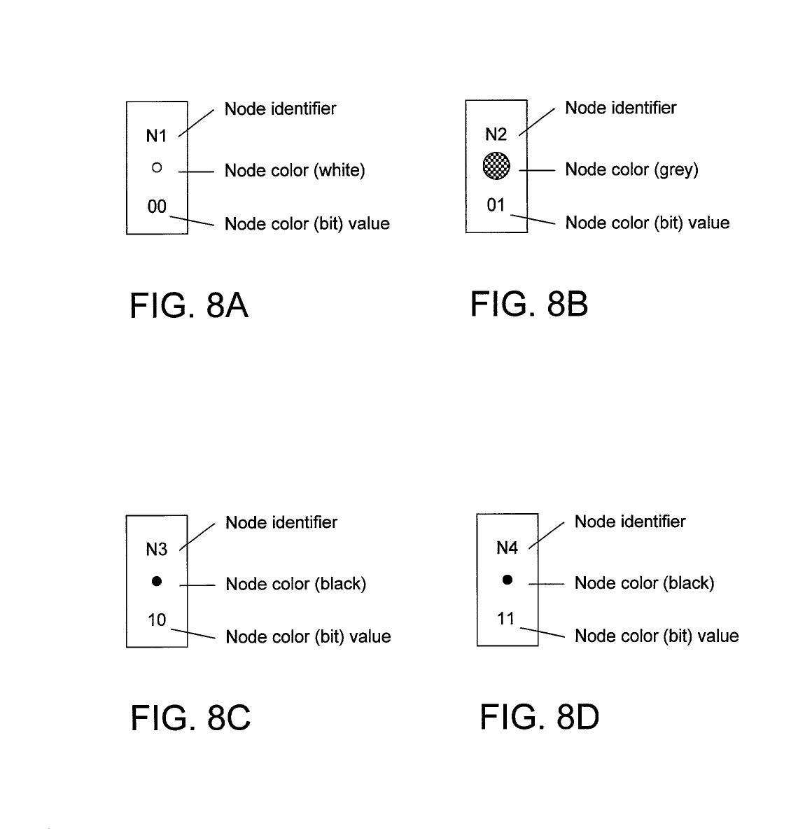

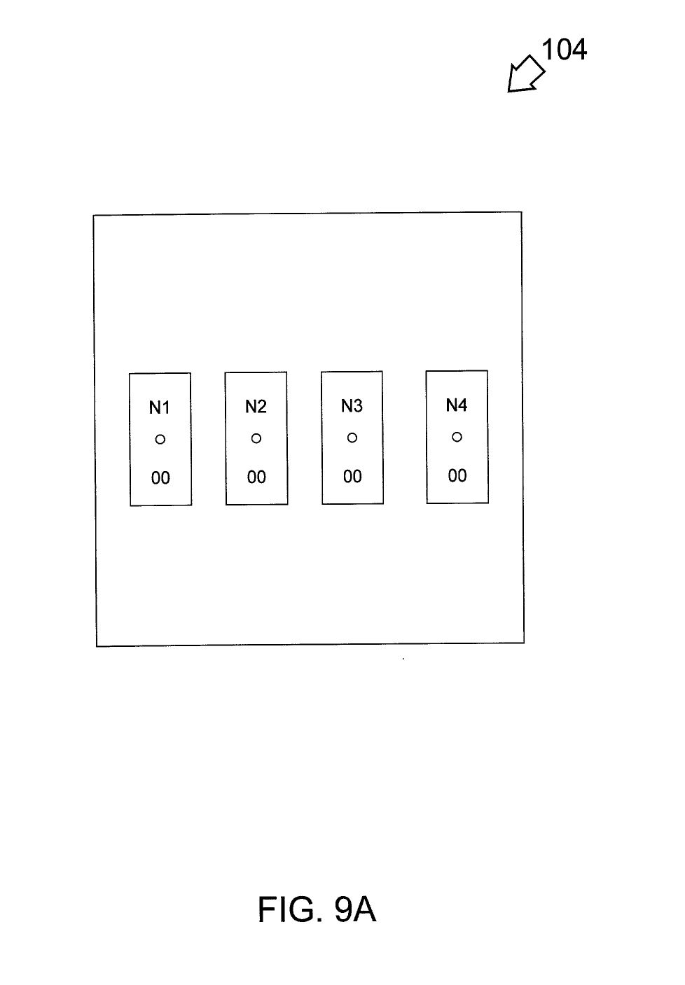

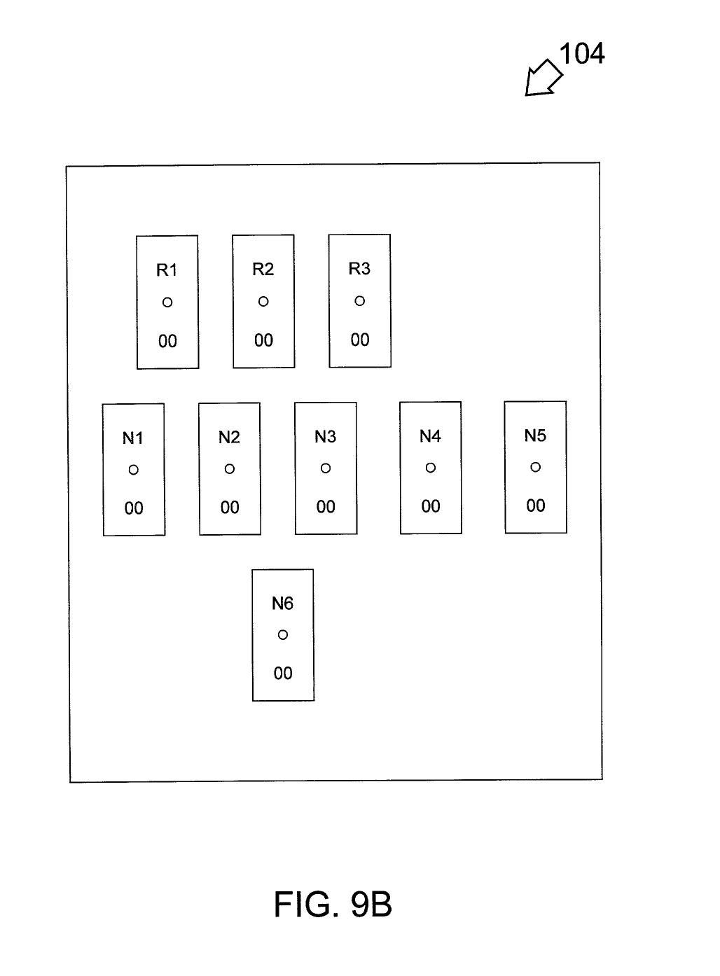

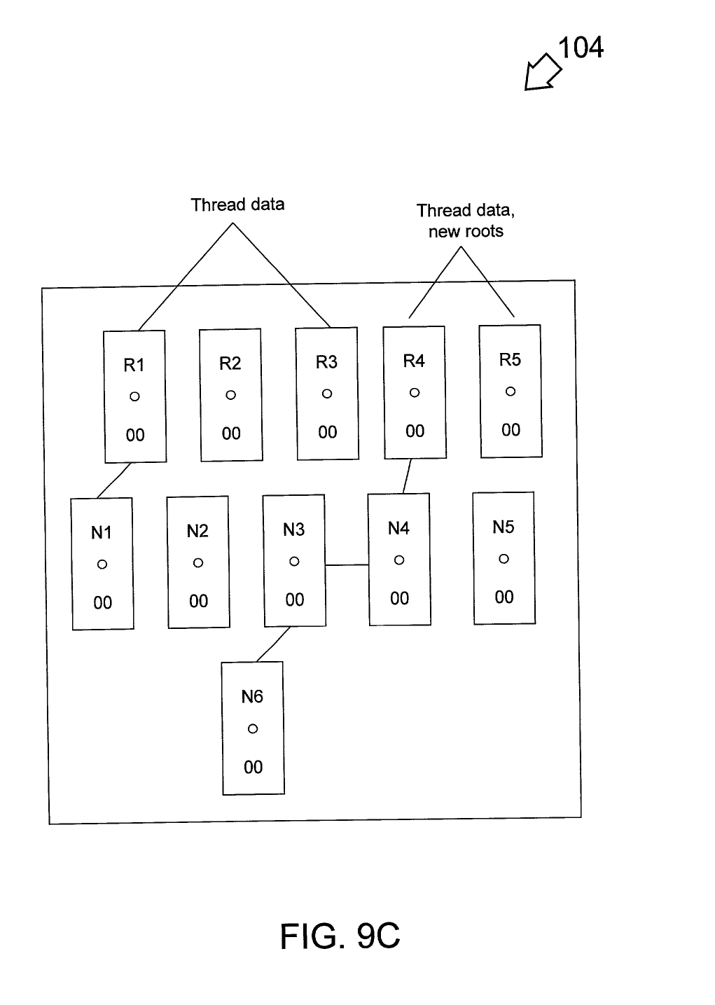

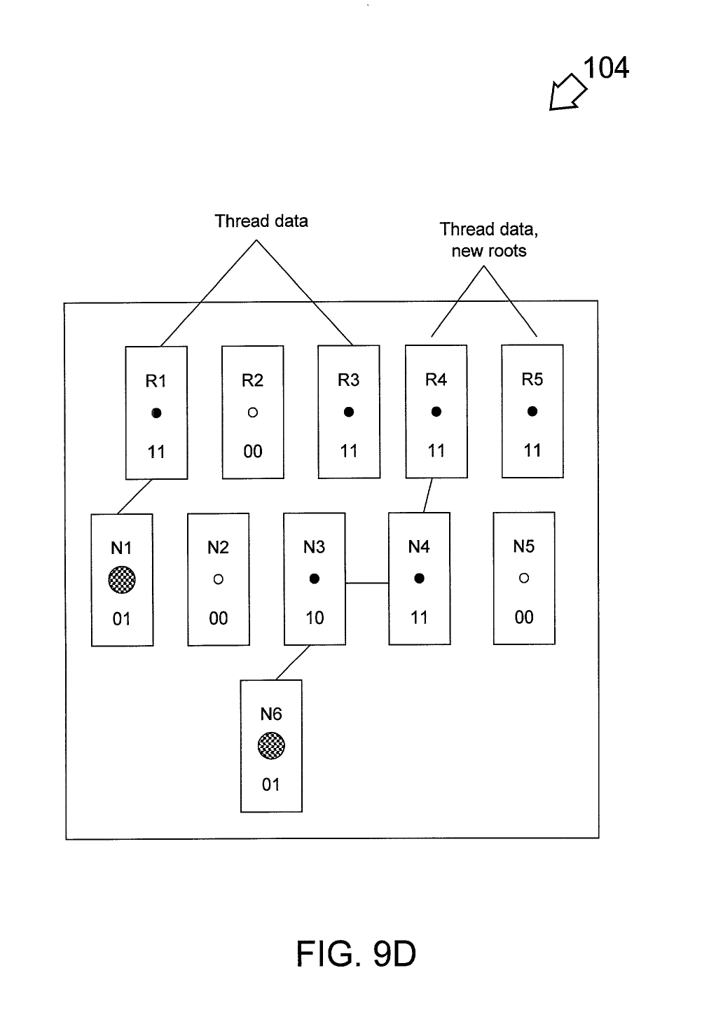

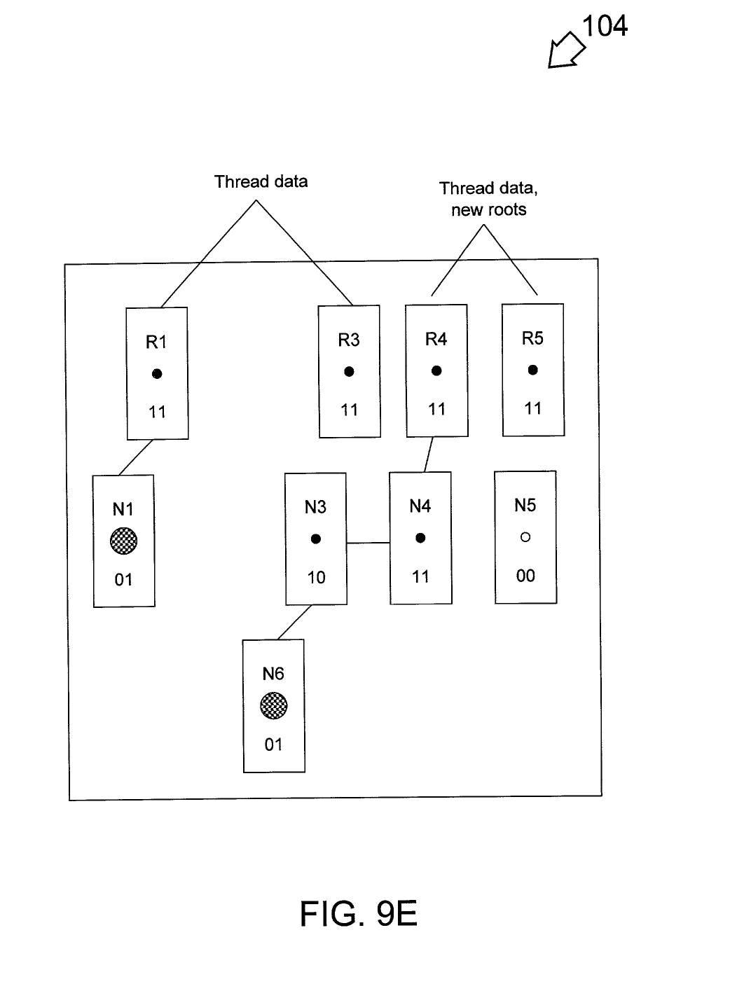

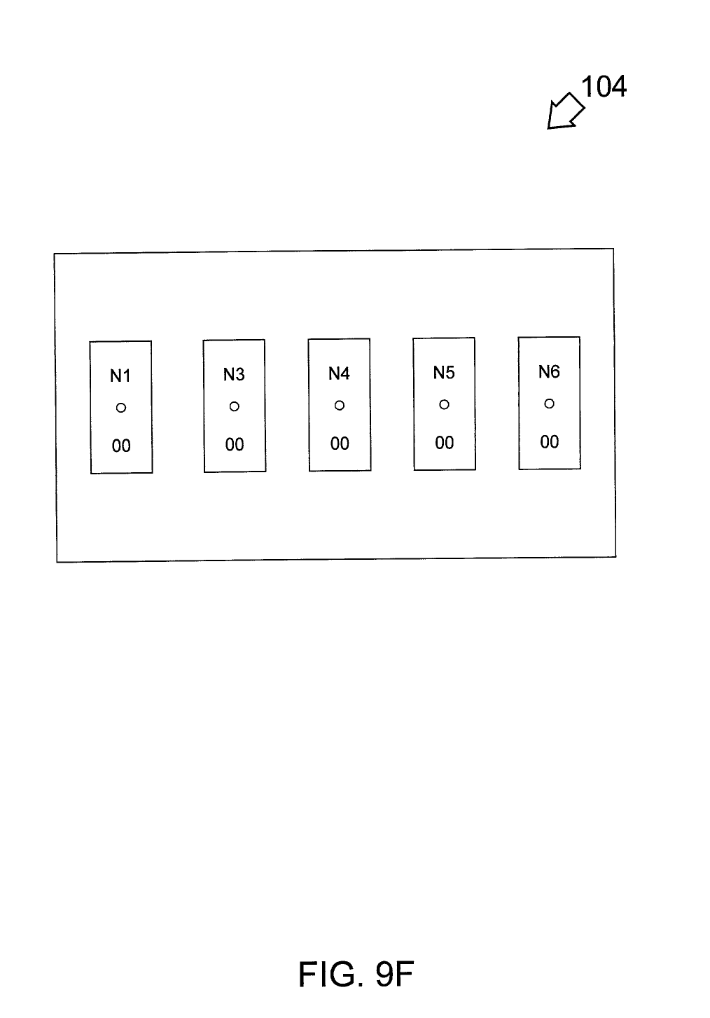

FIGS. 8A-D represent example memory nodes, constructed and operative in accordance with an embodiment of the present invention. These example memory nodes are example keys used to illustrate an example operation of a garbage collection cycle, as shown in FIGS. 9A-F.

FIG. 8A illustrates an example node NI, with a block value of white, represented by “00.”

FIG. 8B illustrates an example node N2, with a block value of grey, represented by “01.”

FIG. 8C illustrates an example node N3, with a block value of black, represented by “10.”

FIG. 8D illustrates an example node N4, with a block value of black, represented by “11.”

FIGS. 9A-F illustrate a memory allocation example of an efficient garbage collection of unused computer memory nodes.

The garbage collector operates conservatively, not reclaiming blocks that become unreachable after the collector recognizes them as reachable. However, those blocks will still be unreachable at the beginning of the next cycle, and will be reclaimed in that cycle.

Moving to FIG. 9A, an exemplary computer memory 104 is shown, with four memory blocks allocated, N1, N2, N3, and N4. At the end of the snapshot phase 1100, all blocks marked with a block value of white (“00”).

As shown in FIG. 9B, a snapshot is taken of the roots R1, R2, and R3. As discussed above, the operation of process 1000 does not stop the execution of application threads. By this time, new memory blocks may have been allocated. Furthermore, new memory blocks may be allocated by the operation of the application threads. Such new memory blocks is shown as blocks N5 and N6. The new nodes (N5 and N6) will not be in the node snapshot (which contains blocks N1 through N4).

During the root phase 1200, all the current roots are obtained from system data. The system data includes all thread, stack, and variable data. As discussed above, roots are direct references to memory blocks used by application threads, stack or variable data.

In active system, the set of reachable blocks is constantly changing. As root phase 1200 begins, shown in FIG. 9C, the garbage collector creates and follows a graph to mark the nodes that are in use. By this time, some of the roots, R2, in the root snapshot may have disappeared, and some new roots, R4 and R5, may have appeared outside the root snapshot. Some nodes, N2, may now be unreachable, and some memory blocks, N3 and N4, may have become unreachable from the original roots, R1 and R3, but have also become reachable from roots, R4, outside the root snapshot, R1 and R3.

In order to create the graph, the garbage collector uses the three-color marking scheme to identify the status of a node:

White the node has not been reached by the garbage collector while building a graph of reachable nodes, starting at the roots.

Grey the node, but not all of its successors, has been reached by the garbage collector.

Black the node and each of its immediate successors has been reached by the garbage collector.

Moving to FIG. 9D, the collector runs iteratively, until all successors have been marked black at which time all white nodes are known to be unreachable (because all successors would have been reached and marked grey or black), in the marking phase 1300.

In FIG. 9E, the garbage collector sweeps the node snapshot to reclaim nodes that are unreachable. In this example, memory block N2 is reclaimed, and thus no longer visible as an allocated memory block. Nodes, N3 and N4, that have become reachable from outside the root snapshot, R1 and R3, will not be reclaimed. Nodes outside the node snapshot, N5 and N6, will not be reclaimed even if unreachable. (This is left for the next reclamation cycle 1000.) The remaining set of nodes (N1, N3 through N6) will be in the node snapshot for the next garbage collection cycle, as shown in FIG. 9F.

Normal execution of threads can make a node (and the corresponding memory block) unreachable from the root snapshot and the node snapshot, while still keeping the memory block in use. In the example above, a path might have existed from R3 to N3, and have been used to establish the path from R4 via N4. The original connection from R3 might have been broken before the garbage collector examined the root R3. If this occurred before the garbage collector reached that node, the garbage collector would not mark the node. Yet the node N3 must be marked, as explained below, in order to prevent the garbage collector from reclaiming it as unused.

These nodes are marked by the hardware when the virtual machine 206 uses references in a way that implies a change in the structure of the graph. Whenever a reference is written to a memory block (such as using the Java™ “aastore,” “putstatic,” and “putfield” instructions), this implies a new arc from one node to another in the graph, and the target of the reference is shaded grey to indicate that the immediate successors of the node must be marked. Whenever a reference is written to a thread stack (i.e., the Java™ “aaload,” “getstatic,” and “getfield” instructions), this implies a new arc from a root to a node in the graph, and the target of the reference is shaded grey to indicate that the immediate successors of the node must be marked. This feature makes it possible to run the garbage collector concurrently with application threads.

It is not necessary to shade the targets of references put on the stack by the allocation operators (i.e., the Java™ “new,” “newarray,” “anewarray,” or “multianewarray” instructions,) because these all create new memory blocks, which will be outside the snapshot of nodes which are candidates for recovery in the current collection cycle. These nodes will be included in the snapshot of candidates for recovery in the next collection cycle.

Requests for memory will run at the priority of the requesting thread.

Unlike previous mark-and-sweep garbage collectors, the garbage collector 210 may run at lower priority than any or all application threads. However, it may be necessary to temporarily promote the garbage collector 210 to a higher priority if an application thread is unable to obtain a memory block, so that the garbage collector can run in preference to the thread long enough to free some memory for use by the thread. Alternatively, in some embodiments, the garbage collector 210 could queue a block to a higher priority thread that would put the block back on the free list.

In yet other embodiments, memory manager 208 may deal with memory shortages by returning when no suitable block is found on the free list. Alternatively, in some embodiments, memory manager 208 retries on each of the two subsequent garbage collections cycles 1000 (so that one complete cycle would intervene between first and third attempts).

The previous description of the embodiments is provided to enable any person skilled in the art to practice embodiments of the invention. The various modifications to these embodiments will be readily apparent to those skilled in the art, and the generic principles defined herein may be applied to other embodiments without the use of inventive faculty. Thus, the present invention is not intended to be limited to the embodiments shown herein, but is to be accorded the widest scope consistent with the principles and novel features disclosed herein.

What is claimed is:

1. An apparatus, comprising:
a computer readable memory having memory blocks with a block value;
a memory manager; and
a garbage collector that can be operated in such a manner to obtain a block snapshot of allocated memory blocks in computer memory from the memory manager, to obtain a root snapshot of all existing roots in the computer memory from system data, to mark the allocated blocks and the existing roots with the block value of garbage blocks, to mark all blocks of computer memory referenced from the root snapshot with the block value of live blocks concurrently while application threads are executing, and to free only the garbage blocks of computer memory within the block snapshot.

2. The apparatus of claim 1, wherein the block value is represented by two bits associated with the memory block.

3. The apparatus of claim 2, wherein the garbage blocks are represented by a block value of “00.”

4. The apparatus of claim 2, wherein the live blocks are represented by a block value of either “10” or “11.”

5. The apparatus of claim 4, wherein the apparatus is a portable wireless device.

6. The apparatus of claim 5, wherein the system data is generated through the use of a Java virtual machine.

7. A memory reclamation method, for reclaiming memory blocks with a block value, comprising:
obtaining a snapshot of allocated blocks in computer memory, resulting in a block snapshot;
obtaining a snapshot of all existing roots in the computer memory from system data, resulting in a root snapshot;
marking the allocated blocks and the existing roots with the block value of garbage blocks;
marking all blocks of computer memory referenced from the root snapshot with the block value of live blocks concurrently while application threads are executing;
freeing only the garbage blocks of computer memory within the block snapshot.

8. The memory reclamation method of claim 7, the marking of all blocks of computer memory referenced from the root snapshot as live further comprises:
(a) examining a single allocated block in the block snapshot;
(b) marking the single allocated block with the block value of a live block, when the single allocated block is referenced from the root snapshot;
(c) repeating (a) and (b) until all the allocated blocks in the block snapshot are examined.

9. The memory reclamation method of claim 8, wherein the marking of the single allocated block as a live block, when the single allocated block is referenced from the root snapshot, is accomplished through greying the block value.

10. The memory reclamation method of claim 9, wherein greying the block value is accomplished through an OR operation between the block value and 1.

11. A memory reclamation method, comprising:
obtaining a snapshot of allocated blocks in computer memory, resulting in a block snapshot;
obtaining a snapshot of all existing roots in the computer memory from system data, resulting in a root snapshot;
marking all blocks of computer memory referenced directly or indirectly from the root snapshot concurrently while application threads are executing;
sweeping only the unmarked blocks of computer memory within the block snapshot.

12. A computer-readable medium encoded with data and instructions, such that when read by a computing device, the computing device is caused to:
obtain a snapshot of allocated blocks in computer memory, resulting in a block snapshot;
obtain a snapshot of all existing roots in the computer memory from system data, resulting in a root snapshot;
mark the allocated blocks and the existing roots with the block value of garbage blocks;
mark all blocks of computer memory referenced from the root snapshot with the block value of live blocks concurrently while application threads are executing;
free only the garbage blocks of computer memory within the block snapshot.

13. The computer-readable medium of claim 12, wherein the marking of all blocks of computer memory referenced from the root snapshot as live further comprises:
(a) examining a single allocated block in the block snapshot;
(b) marking the single allocated block with the block value of a live block, when the single allocated block is referenced from the root snapshot;
(c) repeating (a) and (b) until all the allocated blocks in the block snapshot are examined.

14. The computer-readable medium of claim 13, wherein the marking of the single allocated block as a live block, when the single allocated block is referenced from the root snapshot, is accomplished through greying the block value.

15. The computer-readable medium of claim 14, wherein greying the block value is accomplished through an OR operation between the block value and 1.

16. A computer-readable medium encoded with data and instructions, such that when read by a computing device, the computing device is caused to:
obtain a snapshot of allocated blocks in computer memory, resulting in a block snapshot;
obtain a snapshot of all existing roots in the computer memory from system data, resulting in a root snapshot;
mark all blocks of computer memory referenced directly or indirectly from the root snapshot concurrently while application threads are executing;
sweep only the unmarked blocks of computer memory within the block snapshot.

17. An apparatus, comprising:
means for obtaining a snapshot of allocated blocks in computer memory, resulting in a block snapshot;
means for obtaining a snapshot of all existing roots in the computer memory from system data, resulting in a root snapshot;
means for marking all blocks of computer memory referenced directly or indirectly from the root snapshot concurrently while application threads are executing;
means for sweeping only the unmarked blocks of computer memory within the block snapshot.

18. An apparatus, comprising:
means for obtaining a snapshot of allocated blocks in computer memory, resulting in a block snapshot;
means for obtaining a snapshot of all existing roots in the computer memory from system data, resulting in a root snapshot;
means for marking the allocated blocks and the existing roots with the block value of garbage blocks;
means for marking all blocks of computer memory referenced from the root snapshot with the block value of live blocks concurrently while application threads are executing;
means for freeing only the garbage blocks of computer memory within the block snapshot.

19. The apparatus of claim 18, the means for marking of all blocks of computer memory referenced from the root snapshot as live further comprising:
(a) means for examining a single allocated block in the block snapshot;
(b) means for marking the single allocated block with the block value of a live block, when the single allocated block is referenced from the root snapshot;
(c) means for repeating (a) and (b) until all the allocated blocks in the block snapshot are examined.

20. The apparatus of claim 19, wherein the marking of the single allocated block as a live block, when the single allocated block is referenced from the root snapshot, is accomplished through greying the block value.
